(19) United States
(12) Patent Application Publication
(10) Pub. No.: US 2026/0225160 A1
(43) Pub. Date: Aug. 6, 2026

(54) INTEGRATING COOLING CHANNELS INTO ELECTRODES VIA ADVANCED 3D PRINTING TECHNIQUES

(71) Applicant: MATERIAL HYBRID MANUFACTURING, INC., Miami, FL (US)

(72) Inventors: Christopher Reyes, San Marcos, TX (US); Gabriel Elias, Miami Beach, FL (US); Miles Dotson, Oakland, CA (US); Antonio Nicolas Briceno, Miami, FL (US)

(21) Appl. No.: 19/533,010

(22) Filed: Feb. 6, 2026

Related U.S. Application Data
(60) Provisional application No. 63/755,102, filed on Feb. 6, 2025.

(51) Int. Cl. B22F 12/53; B22F 12/41; H01M 10/613; B33Y 10/00; B33Y 80/00

(52) U.S. Cl. CPC B22F 12/53; B22F 12/41; H01M 10/613; B33Y 10/00; B33Y 80/00

(57) ABSTRACT

The technology includes a method that utilizes a multi-modal printhead to deposit a first electrode material, forming an electrode layer with a defined boundary. Using a second nozzle, a thermally functional non-electrode material is deposited to create a coextensive non-electrode layer containing at least one embedded cooling channel with a tortuous path, fluidly connectable to an inlet and outlet for transporting a cooling medium. A third nozzle deposits a second electrode material, forming a second electrode layer, which may serve as either an anode or cathode. In-situ consolidation, such as laser sintering, is performed on at least one layer. The non-electrode material can be thermally conductive, insulating, or a composite, designed to dissipate heat and improve temperature uniformity. Deposition may involve extrusion, slurry-based, or inkjet methods. The cooling channel’s path length exceeds the straight-line distance between inlet and outlet, with dimensions optimized for heat removal.

### CROSS-REFERENCE TO RELATED APPLICATIONS

This application claims priority to and benefit from U.S. Provisional Patent Application No. 63/755,102, entitled “Integrating Cooling Channels into Electrodes via Advanced 3D Printing Techniques,” filed on February 6, 2025, which is hereby incorporated by reference in its entirety.

### BACKGROUND

An electric battery is a source of electric power including one or more electrochemical cells with external connections for powering electrical devices. When a battery is supplying power, its positive electrode is the cathode and its negative electrode is the anode. The electrode marked negative is the source of electrons. When a battery is connected to an external electric load, those negatively charged electrons flow through the circuit and reach the positive electrode, thus causing a redox reaction by attracting positively charged ions, or cations. Thus, higher energy reactants are converted to lower energy products, and the free-energy difference is delivered to the external circuit as electrical energy.

### BRIEF DESCRIPTION OF THE DRAWINGS

Reference will now be made, by way of example, to the accompanying drawings which show example embodiments of the present application, and in which:

FIG. 1 is a block diagram of two battery production processes in accordance with various embodiments of the present technology.

FIG. 2 is a block diagram of an additive manufacturing (AM) system for manufacturing energy storage devices that enables conformal and custom cooling geometries for various applications.

FIG. 3 is a block diagram of an AM system for manufacturing energy storage devices in accordance with various embodiments of the present technology.

FIG. 4 is a block diagram of an AM system for manufacturing energy storage devices with multiple material nozzles and corresponding calibration, sensor, and sintering components in accordance with various embodiments of the present technology.

FIG. 5 is a flowchart that illustrates a process for integrating a cooling channel into an energy storage device by using additive manufacturing techniques.

FIGS. 6A through 6F depict a sequence of additive manufacturing steps for printing a layered structure of an energy storage device with an embedded cooling channel, beginning from a 3D CAD model.

FIG. 7 is a graph and illustrations showing a comparison of temperature distributions between conventional electrodes and cooling-integrated electrodes.

FIGS. 8A through 8C illustrate an example of a 3D-printed energy storage device with an embedded cooling channel produced using advanced AM methods.

FIG. 9 is a block diagram that illustrates an example of a computer system in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present disclosure relates to advanced thermal management solutions for energy storage devices, such as lithium-ion batteries (LIBs). Specifically, it describes a multi-material, multi-modal three-dimensional (3D) printing system that integrates cooling channels into or between battery electrodes to enhance heat dissipation, safety, and efficiency. The technology is scalable across single-cell, module, and pack-level designs.

As energy storage devices (e.g., lithium-ion batteries) have become critical to high-performance applications, thermal management has emerged as a key factor for safety, efficiency, and lifespan. Excessive heat during operation can accelerate aging and capacity degradation, increase the risk of thermal runaway, and necessitate bulky, complex external cooling systems. To address these drawbacks, the present technology integrates cooling channels adjacent to, within, or between battery electrodes using advanced 3D printing techniques. By incorporating thermally conductive and/or insulating materials, heat is managed at the source, reducing peak operating temperatures by up to 20% or more under high-current conditions.

Embodiments utilize multi-material 3D printing to embed cooling channels directly into energy storage devices, including directly into battery electrodes, enhancing thermal performance while maintaining high energy density. The integrated cooling channels are embedded within, adjacent to, or between electrodes to transport heat away efficiently. Thermally conductive and insulating materials are strategically deposited in target areas to optimize cooling. The technology supports multi-material deposition of materials such as diamond, oxides, ceramics, metals, polymers, and nanocomposites. These channels reduce peak temperatures by 20% or more during high-current operation and improve temperature uniformity, thereby preventing localized hot spots. Advanced 3D printing techniques including, for example, slurry-based and extrusion methods are used for precision material deposition, and laser sintering can be used to enhance structural integrity and conductivity.

In one embodiment, the multi-modal 3D printing system includes a material deposition module, a multi-modal print head, and a post-processing system. The material deposition module prepares and delivers thermally conductive and insulating materials. The multi-modal print head can utilize extrusion, inkjet, and/or laser processing for structural precision. A post-processing system enhances material stability, adhesion, and cooling performance.

The integrated channels enhance heat dissipation during operation, extending battery life, improving safety, and boosting efficiency. Thermally conductive and insulating materials are strategically deposited to maximize cooling without compromising performance. Embodiments can also incorporate AI/ML for process and topology optimization. Enhanced thermal management is achieved through temperature reduction (e.g., reducing operating temperatures by approximately 20%, thereby lowering the risk of thermal runaway) and improved temperature uniformity that mitigates hot spots associated with accelerated degradation.

The technology provides advantages in safety and longevity: improved thermal regulation reduces risks of overheating and thermal runaway, and lower temperatures slow degradation, extending cycle life. It enables enhanced energy density because efficient cooling allows for the use of higher-capacity materials without safety trade-offs, and bipolar stacking enabled by integrated cooling improves volumetric efficiency. It further offers design flexibility through custom cooling configurations that adapt to diverse applications and conformal electrode designs suitable for compact or irregular geometries. Sustainability benefits include reduced reliance on external thermal management systems, minimizing materials and energy use.

Applications include energy storage (e.g., high-performance batteries for drones, electric vehicles, and renewable energy systems); energy conversion (e.g., integration with piezoelectric and thermoelectric devices for efficient heat and power management); and defense and aerospace, where lightweight, compact designs address advanced military applications. Research indicates that effective cooling systems significantly improve LIB performance and that operating within optimal temperature ranges reduces aging and enhances capacity retention. Material selection further shows that high thermal conductivity coolants (e.g., water/glycol mixtures) are effective but require integration with robust structural materials.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

Multi-Material, Multi-Modal 3D Printer for Manufacturing Energy Storage Devices, Modules, and Packs

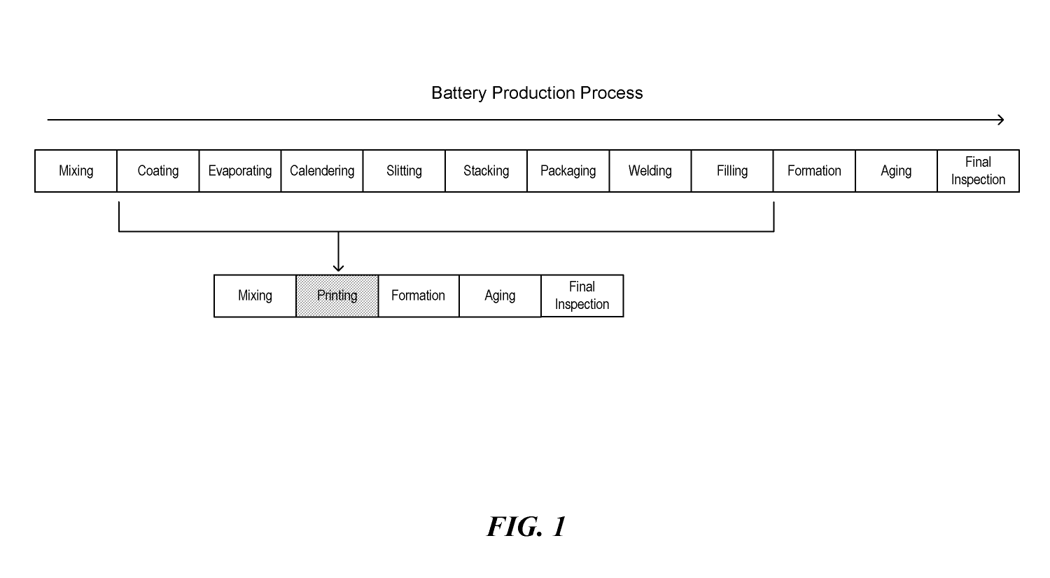

FIG. 1 is a block diagram of two battery production processes. The first production process flow represents a traditional battery production process that includes twelve sequential steps. The first step involves mixing, where raw materials are extracted and processed for use in battery components. The second step, coating, involves depositing electrode materials onto current collectors (i.e., metal materials that collect the current from conductive wiring when the battery is connected to a circuit). The third step, evaporating, removes solvents from the coated electrode materials. The fourth step, calendering, compresses the electrode materials to achieve a desired thickness and density. The fifth step, slitting, cuts the electrode sheets into appropriate dimensions. The sixth step, stacking, arranges the electrode sheets and separators into an electrode assembly. The seventh step, packaging, places the electrode assembly into a cell housing. The eighth step, welding, creates electrical connections between cell components. The ninth step, filling, introduces electrolyte into the cell. The tenth step, formation, involves initial charging and discharging cycles to activate the cell. The eleventh step, aging, allows the cell to stabilize over time. And finally, the twelfth step, final inspection, verifies cell quality and performance.

The second production process flow represents a streamlined approach using the multi-material, multi-modal 3D printing technology of the present technology. This approach consolidates the second through nineth steps of the traditional process into a single printing step, resulting in 5 total steps: mixing, printing, formation, aging, and final inspection. Specifically, printing step deposits electrode materials directly in their final configuration, eliminating the need for separate coating, solvent evaporation, and calendering operations. And, the printing step builds the electrode assembly and casing structure layer by layer, obviating the slitting, stacking, packaging, welding, and filling steps that would otherwise be required to assemble discrete components. Though the printing step is described as replacing the second through nineth steps of the traditional process, in some embodiments, the printing step replaces only a subset of those steps. For example, the printing step may replace the send through eighth step and not replace the filling step.

This approach and its consolidation of the production process has multiple advantages over the traditional production process. For example, this consolidation may reduce manufacturing steps by up to 75% compared to traditional battery manufacturing processes, decrease production time and associated expenses. As another example, the integration of multiple fabrication functions into a single printing step may also reduce the number of parts to construct the energy storage device by combining manufacturing methods and components that would otherwise require separate equipment and handling operations. As an additional example, this approach may reduce material handling between process stages, which may decrease opportunities for contamination or damage to intermediate products.

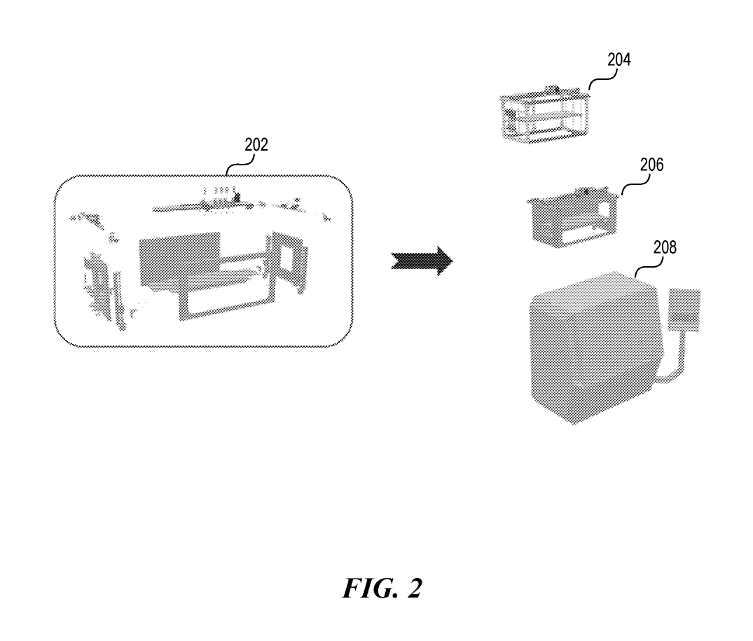

FIG. 2 is a block diagram of an additive manufacturing (AM) device for manufacturing energy storage devices. In FIG. 2, the AM device is shown through multiple views that illustrate the components and configuration of the AM device. The AM device may be configured to fabricate energy storage devices including batteries and supercapacitors. The AM device may fabricate single-cell batteries, multi-cell modules, and multi-module packs within a single platform, enabling integrated manufacturing of energy storage systems at various scales. Applications for the AM device include defense systems, IoT devices, and electric vehicles.

As shown, FIG. 2 includes an exploded component assembly 202. The exploded component assembly 202 illustrates the various disassembled parts of the AM device, including a frame structure, mechanical components, and associated hardware arranged in an exploded view configuration. The exploded component assembly 202 shows how various components of the AM device relate to one another prior to assembly.

FIG. 2 also includes a platform view 204 that shows a frame structure with internal components, including a build surface area (i.e., a platform) where material deposition occurs during fabrication. The platform view 204 illustrates the structural framework that supports the printing operations and maintains alignment of the various subsystems. Next, a drive mechanism view 206 depicts a table-like structure with a frame and mechanical elements positioned above that enable movement of the print head relative to the build surface. The drive mechanism view 206 shows the motion system components that position the print head (described further below) during material deposition operations.

Finally, FIG. 2 also includes a device housing view 208 of a sealed (also referred to herein as enclosed) housing with an attached user interface. The device housing view 208 illustrates the external enclosure of the AM device, which may provide environmental isolation during fabrication operations. The AM device may scale from prototyping operations to large-format manufacturing, accommodating different production volumes and energy storage device sizes within the same platform architecture.

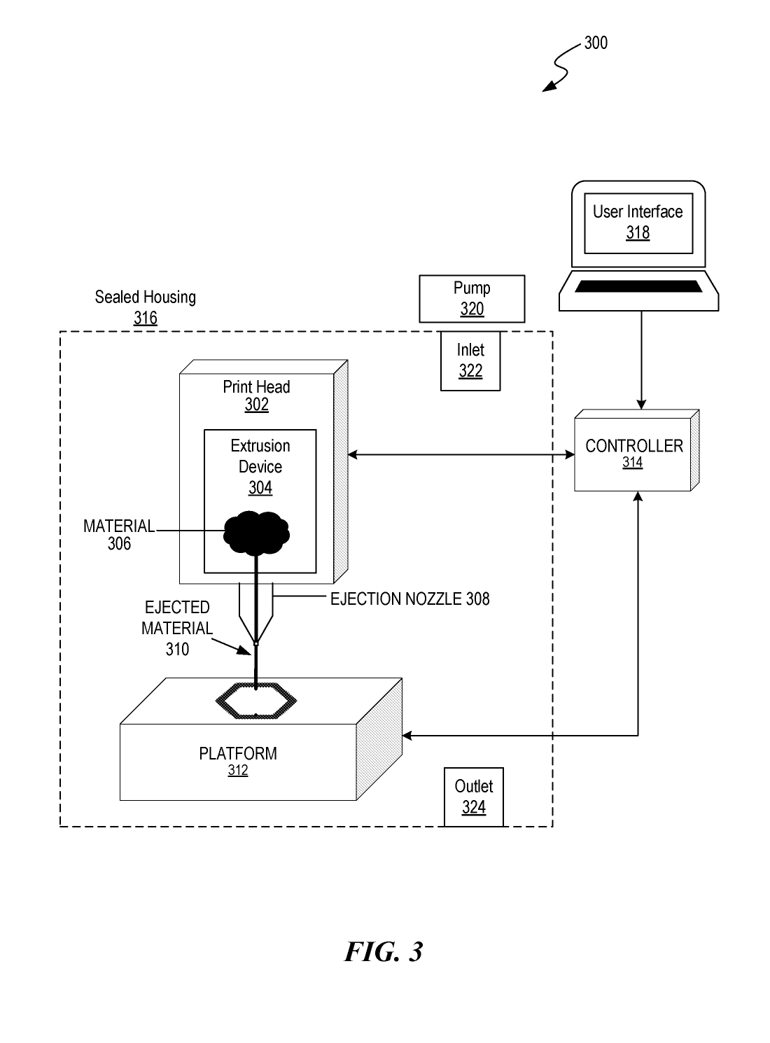

FIG. 3 is a block diagram of an AM system 300 (also referred to herein as a “3D printing system 300”) for manufacturing energy storage devices. The 3D printing system 300 may be configured to fabricate energy storage devices through controlled deposition of multiple materials. The 3D printing system 300 includes a print head 302, an extrusion device 304, material 306, an ejection nozzle 308, ejected material 310, a platform 312, a controller 314, a sealed housing 316, a user interface 318, a pump 320, an inlet 322, and an outlet 324.

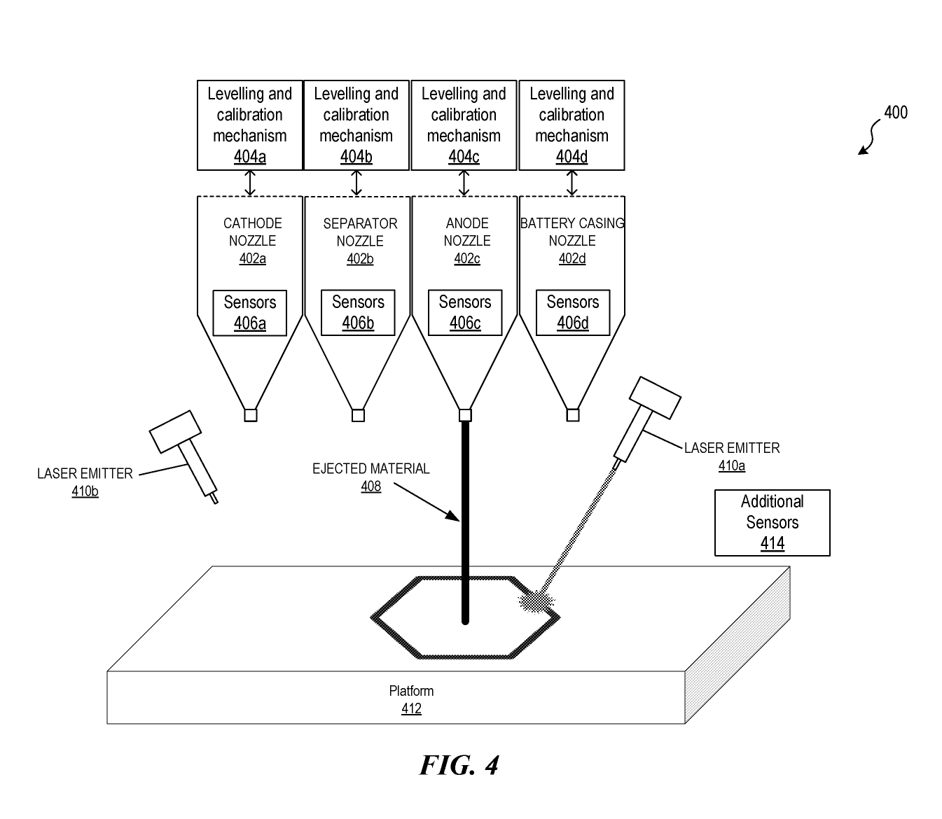

The print head 302 contains the extrusion device 304, which receives the material 306 and processes the material 306 for deposition. The extrusion device 304 may control the flow rate and deposition characteristics of the material 306 as the material 306 passes through the print head 302. The print head 302 may contain more than one extrusion device 304 to control the deposition of more than one material type. Such an embodiment is described further with respect to FIG. 4 below.

The 3D printing system 300 includes a drive mechanism (not shown in FIG. 3 for simplicity) that positions the print head 302 relative to the platform 312 during fabrication operations. In some embodiments, the drive mechanism of the 3D printing system 300 is the same as the drive mechanism of the drive mechanism view 206 of FIG. 2. Across various embodiments, the drive mechanism includes linear actuators, stepper motors, servo motors, or other motion control components that enable precise positioning of the print head 302 along multiple axes. In other embodiments, the drive mechanism moves the print head 302 in a horizontal plane over the surface of the platform 312, allowing the ejection nozzle 308 to deposit material at specified locations. The drive mechanism may also control vertical positioning of the print head 302 to maintain an appropriate distance between the ejection nozzle 308 and the build surface as layers accumulate. In yet further embodiments, the drive mechanism adjusts the angle or position of the ejection nozzle 308 relative to the print head 302. In still further embodiments, the drive mechanism additionally or alternatively moves the platform 312 itself, providing positioning capability through movement of the build surface rather than or in addition to movement of the print head 302 or the ejection nozzle 308. The controller 314 may coordinate operation of the drive mechanism with material deposition from the print head 302 to achieve precise placement of the ejected material 310 according to a predetermined fabrication pattern.

The material 306 may be one or more of an anode material, cathode material, separator material, casing material, or another material used in energy storage device fabrication. The anode material may include, for example, graphite, silicon, lithium titanate, or other materials capable of intercalating or alloying with lithium ions during battery operation. The cathode material may include, for example, lithium cobalt oxide, lithium iron phosphate, lithium nickel manganese cobalt oxide, or other lithium-containing transition metal oxides. The separator material may include, for example, polyethylene, polypropylene, ceramic-coated polymers, or solid electrolyte materials that provide electrical isolation between electrodes while permitting ion transport. The casing material may include, for example, aluminum, stainless steel, polymer composites, or other materials that provide structural support and environmental protection for the internal battery components. The extrusion device 304 feeds the material 306 to the ejection nozzle 308 for controlled deposition.

The ejection nozzle 308 deposits the ejected material 310 onto the platform 312. The platform 312 serves as a build surface where the ejected material 310 accumulates to form a desired structure of an energy storage device. The platform 312 may be positioned (e.g., via the drive mechanism) relative to the print head 302 to enable layer-by-layer construction of energy storage device components. The ejected material 310 may be deposited in patterns corresponding to the geometry of battery electrodes, separators, or casings.

The controller 314 manages operations of the 3D printing system 300. The controller 314 is connected to one or more of the print head 302, the extrusion device 304, the platform 312, and the pump 320 (as well as the sensor and laser components described with respect to FIG. 4 below) to coordinate the operation of these components during fabrication processes. The controller 314 may control the drive mechanism that moves the print head 302 over a surface of the platform 312, as described with reference to the drive mechanism view 206 of FIG. 2. In some embodiments, the controller 314 may also control a drive mechanism associated with the platform 312 to provide additional positioning capability. The controller 314 may synchronize material deposition with print head positioning to achieve precise placement of the ejected material 310.

The user interface 318 is connected to the controller 314. The user interface 318 provides an interface for users to input commands, monitor the printing process, and make adjustments as needed. In some embodiments, the user interface 318 displays data associated with the 3D printing system 300, including deposition parameters, environmental conditions, and process status information. In other embodiments, the user interface 318 receives inputs from a user to augment or modify instructions stored in memory associated with the controller 314, enabling manual or automated process adjustments during fabrication operations.

In some embodiments, the user interface 318 represents a computing device that includes the functions of the controller 314. In other embodiments, the user interface 318 represents a computing device that includes a datastore. In such embodiments, the computing device is capable of storing detailed logs of deposition parameters, environmental conditions, and sensor feedback to the datastore for quality assurance and diagnostic purposes.

Turning to the enclosure and environmental control of the present technology, the 3D printing system 300 includes the sealed housing 316, the pump 320, the inlet 322, and the outlet 324. The sealed housing 316 encloses at least the print head 302, the extrusion device 304, the material 306, the ejection nozzle 308, and the platform 312 to provide a controlled environment for fabrication operations. The sealed housing 316 isolates the internal components of the 3D printing system 300 from ambient atmospheric conditions during material deposition and processing. This environmental isolation may protect reactive battery materials from exposure to moisture, oxygen, and other atmospheric constituents that could cause degradation or undesirable chemical reactions during fabrication.

The pump 320 is connected to the sealed housing 316 through the inlet 322. The pump 320 may introduce an inert gas into the sealed housing 316 to establish and maintain an inert atmosphere within the enclosure. Examples of the inert gas include and nitrogen. Argon and nitrogen are chemically unreactive under typical processing conditions and may displace oxygen and moisture from the fabrication environment. The use of an inert atmosphere may minimize oxidation and contamination of reactive battery materials, including anode materials and cathode materials that may be sensitive to atmospheric exposure during deposition and sintering operations.

The outlet 324 provides an exit path from the sealed housing 316, enabling circulation of the atmosphere within the enclosure. The pump 320, the inlet 322, and the outlet 324 form a circulation system that continuously moves the inert gas through the sealed housing 316. This circulation may maintain uniform atmospheric conditions throughout the fabrication volume and may remove particulates, vapors, or other contaminants generated during material deposition or laser sintering operations.

In some embodiments, the circulation system includes a filter configured to filter the inert gas that exits the sealed housing 316 through the outlet 324. In some embodiments, the filter comprises high-efficiency filtration units that remove particulates and contaminants from the circulating inert gas before the inert gas is reintroduced into the sealed housing 316. The filtration units may maintain a clean, stable environment throughout the fabrication process by capturing airborne particles, material debris, and other contaminants that could otherwise accumulate within the sealed housing 316 or deposit on fabricated components. The combination of inert gas circulation and filtration may enable extended fabrication operations while maintaining atmospheric purity within the sealed housing 316.

FIG. 4 is a block diagram of an AM system 400 (also referred to herein as a 3D printing system 400) for manufacturing energy storage devices with multiple material nozzles and corresponding calibration, sensor, and sintering components. The 3D printing system 400 is further described above with respect to the 3D printing system 300 of FIG. 3. As shown in FIG. 4, The 3D printing system 400 includes multiple deposition nozzles 402 (as represented by cathode nozzle 402a, separator nozzle 402b, anode nozzle 402c, and battery casing nozzle 402d) that are each associated with one of the leveling and calibration mechanisms 404 (as represented by leveling and calibration mechanism 404a, leveling and calibration mechanism 404b, leveling and calibration mechanism 404c, leveling and calibration mechanism 404d) and with sensors 406 (as represented by sensors 406a, sensors 406b, sensors 406c, and sensors 406d). Additionally, the 3D printing system 400 includes ejected material 408, multiple laser emitters 410 (as represented by laser emitter 410a and laser emitter 410b), a platform 412, and additional sensors 414.

Each of the cathode nozzle 402a, the separator nozzle 402b, the anode nozzle 402c, and the battery casing nozzle 402d is dedicated to depositing a specific battery component material. Though shown with four nozzles associated with four battery components, the present technology is not so limited. Accordingly, the present technology includes embodiments with a single nozzle and a single material, embodiments with three nozzles and three materials, embodiments with ten nozzles and ten materials, and etc. In the embodiment of FIG. 4, the cathode nozzle 402a is configured to deposit cathode material, which may include lithium-containing transition metal oxides or other cathode compositions suitable for energy storage applications. The separator nozzle 402b is configured to deposit separator material, which may include polymer-based materials, ceramic materials, or solid electrolyte compositions that provide electrical isolation between electrodes while permitting ion transport. The anode nozzle 402c is configured to deposit anode material, which may include graphite, silicon-based compounds, lithium titanate, or other materials capable of storing lithium ions during battery operation. The battery casing nozzle 402d is configured to deposit casing material, which may include metals, polymers, or composite materials that provide structural support and environmental protection for internal battery components.

Assigning each nozzle to a single material type, as shown, is expected to reduce cross-contamination between different battery materials during fabrication. By maintaining separate deposition pathways for the cathode material, the separator material, the anode material, and the casing material, the 3D printing system 400 may preserve material purity throughout the fabrication process. This configuration may also enable independent optimization of deposition parameters for each material type, as different materials may have different viscosity characteristics, flow rates, and deposition requirements. However, despite these advantages, the present technology is capable of assigning more than one material type to each of the nozzles.

The deposition nozzles 402 can each be included in a single print head (e.g., the print head 302 of FIG. 3). A drive mechanism, such as the drive mechanism described with reference to the drive mechanism view 206 of FIG. 2, may position each nozzle over the platform 412 during fabrication operations. The platform 412 (described further above with respect to the platform 312 of FIG. 3) serves as a build surface where ejected material 408 accumulates to form the energy storage device structure. The 3D printing system 400 may selectively activate each nozzle according to a predetermined fabrication sequence, depositing layers of casing material, anode material, separator material, and cathode material to construct a complete battery cell or module.

The leveling and calibration mechanisms 404 enable independent adjustment of each respective nozzle to accommodate differences in material viscosity, flow rate, and deposition characteristics. Each leveling and calibration mechanism 404a, 404b, 404c, 404d may be mechanically coupled to the corresponding nozzle assembly, providing positional adjustment capability along one or more axes. The leveling and calibration mechanism 404a associated with the cathode nozzle 402a may adjust the orientation and height of the cathode nozzle 402a to compensate for variations in cathode material viscosity and flow behavior. Similarly, the leveling and calibration mechanism 404b may adjust the separator nozzle 402b, the leveling and calibration mechanism 404c may adjust the anode nozzle 402c, and the leveling and calibration mechanism 404d may adjust the battery casing nozzle 402d.

Different battery materials may exhibit different rheological properties that affect deposition behavior. For example, cathode slurries containing lithium-containing transition metal oxides may have different viscosity characteristics compared to anode slurries containing graphite or silicon-based compounds. Separator materials and casing materials may similarly exhibit distinct flow rates and deposition characteristics based on their respective compositions. The independent leveling and calibration mechanisms 404 allow each of the deposition nozzles 402 to be adjusted according to the specific properties of the material that the nozzle deposits, rather than requiring a single calibration setting to accommodate all material types.

The sensors 406 are integrated into each nozzle assembly and continuously monitor deposition quality and alignment. The sensors 406a associated with the cathode nozzle 402a may detect parameters related to the deposition of cathode material, including material flow rate, deposition width, layer thickness, and positional alignment relative to the platform 412. The sensors 406b, the sensors 406c, and the sensors 406d perform analogous monitoring functions for the separator nozzle 402b, the anode nozzle 402c, and the battery casing nozzle 402d, respectively.

In some embodiments, the sensors 406 include optical sensors, proximity sensors, flow sensors, or other sensing devices capable of generating measurement data during deposition operations. For example, the sensors 406 may detect variations in material flow that indicate changes in material viscosity or nozzle condition. In other embodiments, the sensors 406 monitor the position of the ejected material 408 relative to a target deposition location, enabling detection of alignment deviations.

The measurement data generated by the sensors 406 enable real-time feedback for independent calibration adjustments during operation. In some embodiments, the controller (e.g., the controller 314 described above with respect to FIG. 3) receives the measurement data from the sensors 406 and process the measurement data to determine whether calibration adjustments are warranted. When the measurement data indicates a deviation from target deposition parameters, the controller signals (i) the corresponding leveling and calibration mechanism 404 to adjust the associated nozzle and/or (ii) the drive mechanism to adjust the print head and/or the platform 412. This closed-loop feedback configuration is expected to enable the 3D printing system 400 to maintain deposition quality throughout fabrication operations, compensating for variations in material properties, environmental conditions, or component wear that may occur during extended printing sessions.

As shown in FIG. 4, the ejected material 408 is deposited from the deposition nozzles 402 onto the platform 412 during fabrication operations. As each nozzle deposits material onto the platform 412, the ejected material 408 accumulates in layers to form the structure of the energy storage device. The platform 412 receives the ejected material 408 from the cathode nozzle 402a, the separator nozzle 402b, the anode nozzle 402c, and the battery casing nozzle 402d according to a predetermined fabrication sequence controlled by the controller.

In some embodiments, the 3D printing system 400 includes the laser emitters 410. The laser emitters 410 are configured to perform post-processing sintering of the battery materials after deposition. In some embodiments, the 3D printing system 400 includes as many laser emitters as there are material types deposited by the deposition nozzles 402. For example, in embodiments where four nozzles deposit four distinct material types, the 3D printing system 400 may include four laser emitters, with each laser emitter tuned to the sintering requirements of a corresponding material type. In other embodiments, the number of laser emitters corresponds to the number of nozzles in the print head (e.g., the print head 302 of FIG. 3).

Each of the laser emitters 410 are tuned to specific sintering requirements of the deposited materials. The tuning of each laser emitter may include selection of a laser wavelength, power level, pulse duration, and beam profile characteristics that correspond to the thermal and optical properties of the target material. Different battery materials may require different sintering parameters to achieve desired microstructures and electrical properties. For example, cathode materials containing lithium-containing transition metal oxides may require different laser parameters compared to anode materials containing graphite or silicon-based compounds. The laser emitters may be configured to deliver thermal energy (i.e., a laser or a laser beam) to the deposited material in a manner that promotes densification, grain growth, or other microstructural changes that enhance the electrochemical performance of the fabricated battery components. Accordingly, the laser emitter 410a may be tuned to sinter the anode material deposited from the anode nozzle 402c and the laser emitter 410b may be tuned to sinter the separator material deposited from the separator nozzle 402b.

In some embodiments, the controller (e.g., the controller 314 described above with respect to FIG. 3) coordinates selective activation of the laser emitters 410 based on the type of material deposited and the location of the deposited material on the platform 412. This coordination allows for customized sintering protocols that are tailored to each material type and deposition region. In some embodiments, the controller activates a specific laser emitter immediately after deposition of a corresponding material type, enabling in-situ sintering as the fabrication process proceeds. In other embodiments, the controller activates multiple laser emitters in sequence or simultaneously to achieve uniform sintering across a deposited layer. The selective activation capability enables the 3D printing system 400 to apply different sintering treatments to different regions of the energy storage device structure based on the material composition and geometric requirements of each region.

In some embodiments, the 3D printing system 400 includes a laser subsystem mount that positions the laser emitters 410 substantially over the surface of the platform 412. The laser subsystem mount may be configured to orient each of the laser emitters 410 toward the deposited material prior to activation, enabling the laser to be pointed at the ejected material 408 on the platform 412 before sintering operations commence. In some embodiments, the laser subsystem mount is a fixed structure that maintains the laser emitters 410 in a stationary position relative to the platform 412, with the laser emitters 410 oriented to cover the build area where material deposition occurs. In other embodiments, the laser subsystem mount includes adjustable positioning elements that allow the orientation of individual laser emitters to be modified based on the location of deposited material. In yet further embodiments, the drive mechanism that moves the print head over the surface of the platform 412 is further configured to move the laser sintering subsystem, enabling coordinated positioning of both the deposition nozzles and the laser emitters during fabrication operations. In still further embodiments, the 3D printing system 400 includes a second drive mechanism that is dedicated to moving the laser sintering subsystem over the surface of the platform 412 independently of the print head positioning. Such a configuration may allow the laser emitters 410 to be positioned over specific regions of deposited material while the print head continues deposition operations in other regions, potentially reducing overall fabrication time by enabling concurrent deposition and sintering activities.

As shown in FIG. 4, the 3D printing system 400 includes additional sensors 414. The additional sensors 414 are positioned throughout the sealed housing (e.g., the sealed housing 316 of FIG. 3) and/or are integrated into the components (e.g., the platform 412) described above. Accordingly, in some embodiments, the additional sensors 414 are positioned adjacent to the platform 412 to provide deposition and topology verification. In such embodiments, the additional sensors 414 comprise optical sensors or profilometric sensors that are employed to verify the topology of each deposited layer. The optical sensors may include cameras, laser scanners, or other imaging devices that capture visual information about the surface of the ejected material 408. The profilometric sensors may include contact profilometers, optical profilometers, or interferometric sensors that measure surface height variations across the deposited layers.

Further, in other embodiments, the additional sensors 414 detect variations in layer thickness, surface uniformity, and potential defects in the ejected material 408. Layer thickness variations may indicate inconsistencies in material flow rate, nozzle height, or deposition speed during fabrication. Surface uniformity measurements may reveal regions of uneven material distribution, porosity, or surface roughness that could affect the electrochemical performance of the fabricated battery components. Defect detection may identify voids, cracks, inclusions, or other anomalies that could compromise the structural integrity or electrical properties of the energy storage device.

In some embodiments, sensors are integrated into the platform 412 to provide additional measurement capability from below the deposited layers. Platform-integrated sensors may include load cells that measure the mass of deposited material, temperature sensors that monitor the thermal state of the build surface, or proximity sensors that detect the presence and position of deposited material.

In other embodiments, the additional sensors 414 work in conjunction with the sensors 406 to form a sensor system that monitors the fabrication process. Data from the sensor system is processed by the controller (e.g., the controller 314 of FIG. 3), which evaluates the measurement data against target parameters for each deposited layer. When the controller detects discrepancies between the measured values and the target parameters, the controller may initiate corrective actions (i.e., through the drive mechanism and/or the levelling and calibration mechanisms 404) to address the detected deviations.

In some embodiments, the controller adjusts deposition parameters in response to detected discrepancies. Deposition parameter adjustments may include changes to material flow rate, nozzle height, deposition speed, or print head positioning to compensate for detected variations in layer thickness or surface uniformity. In other embodiments, the controller signals the laser emitters to perform corrective sintering operations. Corrective sintering may include additional laser passes over regions where defects or insufficient densification have been detected, or modified laser parameters to address specific material conditions identified by the sensor system. This feedback loop enables the 3D printing system 400 to maintain fabrication quality throughout the manufacturing process by detecting and responding to process variations in real time.

### Embedded Cooling Channels

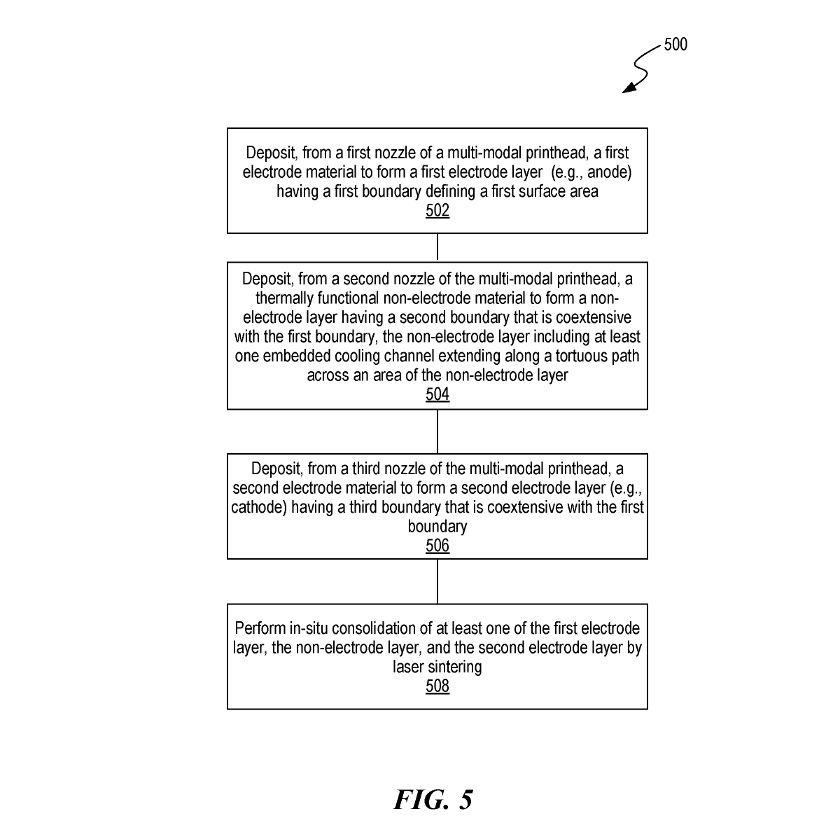

FIG. 5 illustrates a flowchart of a process 500 for integrating a cooling channel into an energy storage device (e.g., a lithium-ion battery, a solid-state battery, a sodium-ion battery, or a supercapacitor) using additive manufacturing (AM) techniques. The process 500 is performed by a system including a multi-material, multi-modal 3D printer.

At 502, the system deposits, from a first nozzle of a multi-modal printhead, a first electrode material to form a first electrode layer. The first electrode layer has a first boundary defining a first surface area.

At 504, the system deposits, from a second nozzle of the multi-modal printhead, a thermally functional non-electrode material to form a non-electrode layer. The non-electrode layer has a second boundary that is coextensive with the first boundary of the first electrode layer. In some examples, the non-electrode material includes a metal, ceramic, diamond, oxide, polymer, or nanocomposite configured to enhance thermal conductivity and mechanical stability of the energy storage device.

The non-electrode layer includes at least one embedded cooling channel extending along a tortuous path across an area of the non-electrode layer. In some examples, the embedded cooling channel has a serpentine, helical, fractal, lattice, or branched geometry. The embedded cooling channel is fluidly connectable to an inlet and an outlet and configured to transport a cooling medium (e.g., a liquid, gas, phase-change material, or thermally conductive gel). The cooling channel has a path length greater than a straight-line distance between its fluidic inlet and outlet and a cross-sectional dimension selected to enable heat removal during device operation. In some examples, the cooling channel includes a thermally conductive lining material configured to increase heat conduction to the cooling medium. In some examples, the system forms a header or manifold in fluid communication with the cooling channel to interface with a cooling loop at the cell, module, or pack level.

At 506, the system deposits, from a third nozzle of the multi-modal printhead, a second electrode material to form a second electrode layer. The second electrode layer has a third boundary that is coextensive with the first boundary of the first electrode layer. The first electrode layer is an anode and the second electrode layer is a cathode, or vice versa. In some examples, the printhead includes an alignment system configured to maintain registration among the first electrode layer, the non-electrode layer, and the second electrode layer within a predetermined tolerance. In some examples, the embedded cooling channel is positioned between the first electrode layer and the second electrode layer and extends across the coextensive boundary. In some examples, the electrode materials include a nanostructured active material configured to enhance thermal and mechanical stability. The system can also print electrical interconnects and current collectors aligned with the first and second electrode layers.

At 508, the system performs in-situ consolidation of at least one of the first electrode layer, the non-electrode layer, and the second electrode layer by laser sintering. The laser sintering can occur contemporaneously with deposition of at least one layer to provide in-situ consolidation. In some examples, the depositing steps include the use of a pellet material, extrusion, slurry-based deposition, or inkjet deposition. The system can also perform post-processing by thermal annealing, UV curing, chemical curing, pressure-assisted densification, or laser remelting to improve adhesion, conductivity, or structural integrity.

The non-electrode material can include at least one of a thermally conductive material, a thermally insulating material, or a composite thereof, and, as a result, is configured to dissipate heat generated by the first and/or second electrode layers and to improve temperature uniformity across the energy storage device. In some examples, the non-electrode layer includes regions of thermally insulating material positioned to reduce parasitic heat transfer to adjacent cells or components.

Therefore, the resulting energy storage device includes: (i) a first electrode layer formed of a first electrode material, having a first boundary defining a first surface area; (ii) a non-electrode layer positioned adjacent to the first electrode layer, having a second boundary coextensive with the first boundary, and including a thermally functional material and at least one embedded cooling channel extending along a tortuous path across an area of the non-electrode layer; and (iii) a second electrode layer formed of a second electrode material, having a third boundary coextensive with the first boundary, and positioned on an opposite side of the non-electrode layer from the first electrode layer. The embedded cooling channel is fluidly connectable to an inlet and an outlet and configured to transport a cooling medium. The first electrode layer is an anode and the second electrode layer is a cathode, or vice versa. The device further includes one or more consolidated regions in at least one of the first electrode layer, the non-electrode layer, and the second electrode layer to provide structural integrity and interlayer adhesion. The thermally functional material of the non-electrode layer includes at least one of a thermally conductive material, a thermally insulating material, or a composite thereof, and is configured to dissipate heat generated by the electrode layers. The embedded cooling channel has a path length greater than a straight-line distance between its fluidic inlet and outlet, includes a serpentine, helical, fractal, lattice, or branched geometry, and extends substantially across the coextensive boundary of the non-electrode layer.

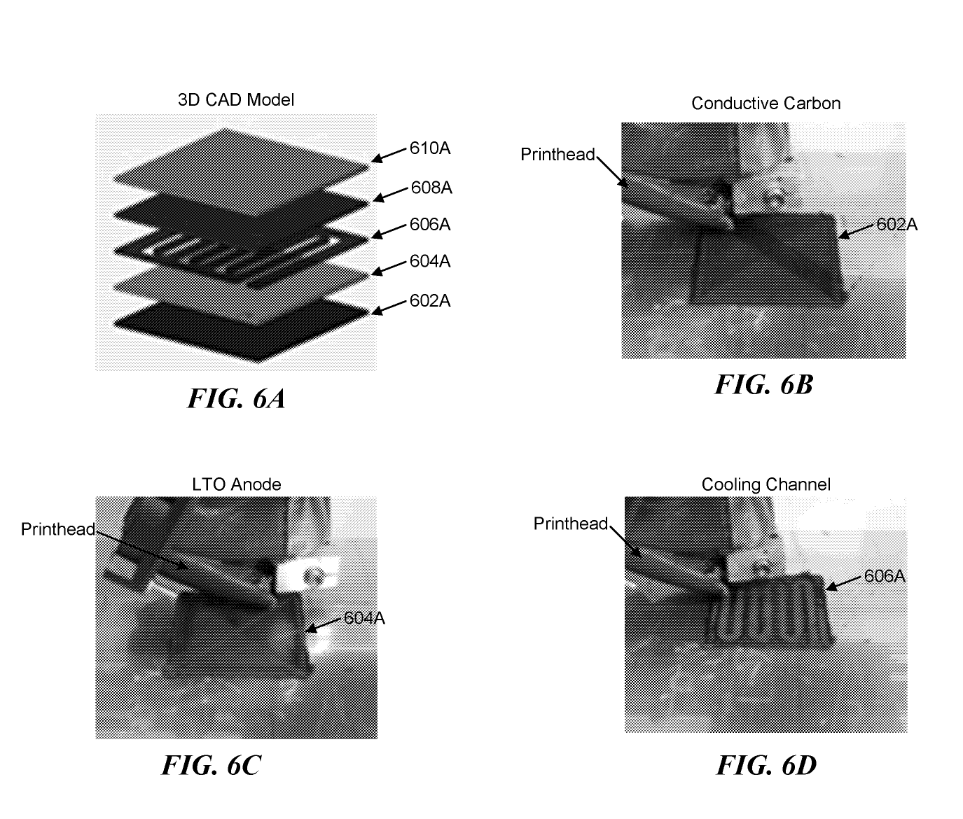

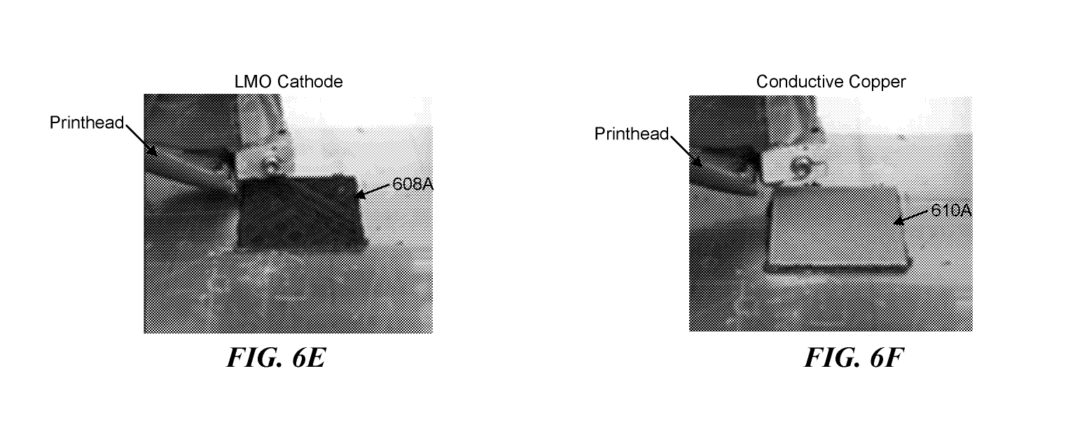

FIGS. 6A through 6F depict a sequence of additive manufacturing steps for printing a layered structure of an energy storage device with an embedded cooling channel, beginning from a 3D CAD model. FIG. 6A shows the 3D CAD model and an exploded view of the device comprising, in order, a conductive carbon layer 602A, an LTO anode layer 604A, a cooling layer 606A, an LMO cathode layer 608A, and a conductive copper layer 610A. FIGS. 6B through 6F illustrate the fabrication of each respective layer via additive manufacturing. Specifically, FIG. 6B illustrates printing of the conductive carbon layer 602A; FIG. 6C illustrates printing of the LTO anode layer 604A; FIG. 6D illustrates printing of the cooling layer 606A, which incorporates a serpentine cooling channel; FIG. 6E illustrates printing of the LMO cathode layer 608A; and FIG. 6F illustrates printing of the conductive copper layer 610A.

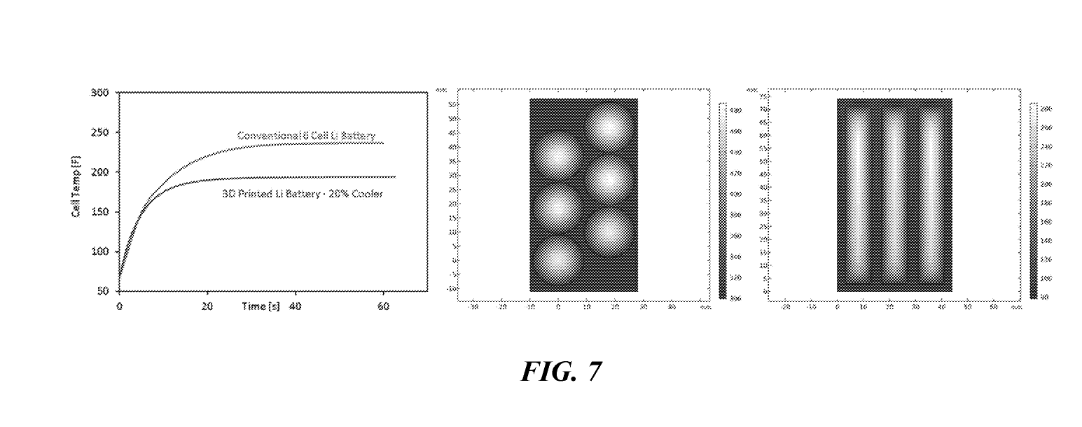

FIG. 7 is a graph and illustrations showing a comparison of temperature distributions between conventional electrodes and cooling-integrated electrodes. As shown, the temperature of the 3D-printed lithium battery is at least 20% lower than that of a conventional six-cell lithium battery.

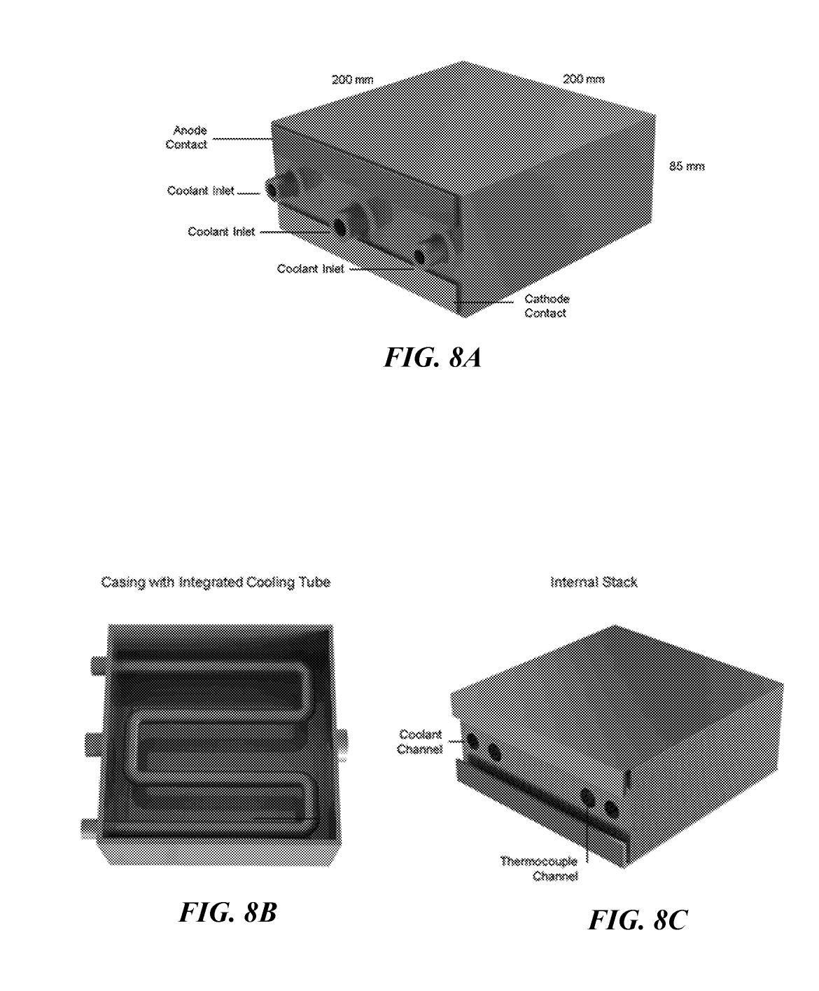

FIGS. 8A through 8C illustrate an example of a 3D-printed energy storage device with an embedded cooling channel produced using advanced additive manufacturing methods. FIG. 8A shows a battery designed for continuous, end-to-end printing. In one embodiment, the battery is rated at 100 V and 98 Ah, weighs approximately 7.8 kg, and has a compact square footprint of 200 mm by 200 mm with a height of 85 mm. The estimated continuous print time for this embodiment is approximately 24 hours.

The battery is designed with integrated thermal management, including internal cooling channels and temperature probes. FIG. 8B illustrates the battery casing with an integrated cooling tube, and FIG. 8C illustrates the internal layer stack. The design supports versatility across applications: In addition to the high-power configuration (100 V, 98 Ah, ~7.8 kg), the architecture can be configured for lower-voltage, high-capacity setups (e.g., 12 V) within the same compact volume. Potential applications include electric vehicles, consumer electronics, and other energy storage use cases. The device is intended to offer a reliable and cost-effective solution, emphasizing simplicity and manufacturing efficiency.

### Computer System

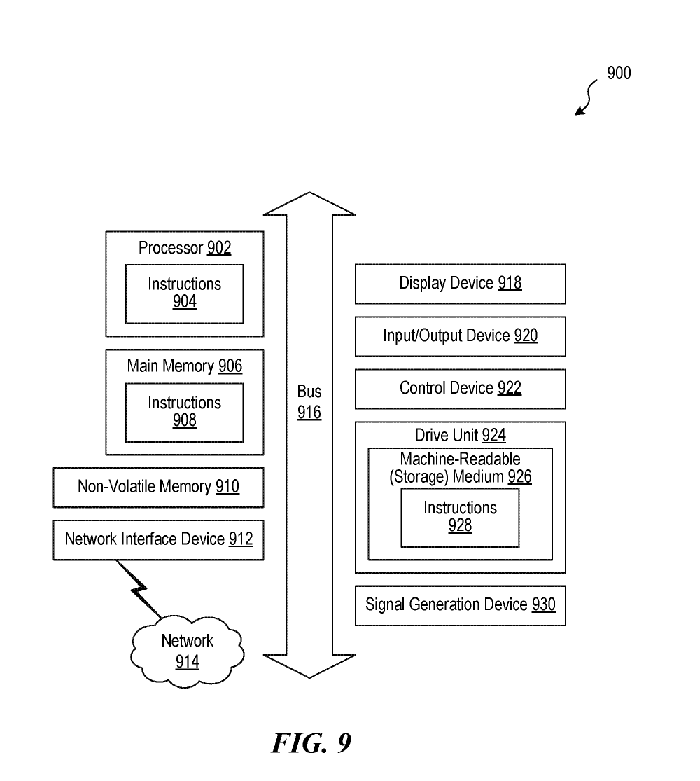

FIG. 9 is a block diagram that illustrates an example of a computer system 900 in which at least some operations described herein can be implemented. As shown, the computer system 900 can include: one or more processors 902, main memory 906, non-volatile memory 910, a network interface device 912, a display device 918, an input/output device 920, a control device 922 (e.g., keyboard and pointing device), a drive unit 924 that includes a machine-readable (storage) medium 926, and a signal generation device 930 that are communicatively connected to a bus 916. The bus 916 represents one or more physical buses and/or point-to-point connections that are connected by appropriate bridges, adapters, or controllers. Various common components (e.g., cache memory) are omitted from FIG. 9 for brevity. Instead, the computer system 900 is intended to illustrate a hardware device on which components illustrated or described relative to the examples of the figures and any other components described in this specification can be implemented.

The computer system 900 can take any suitable physical form. For example, the computer system 900 can share a similar architecture as that of a server computer, personal computer (PC), tablet computer, mobile telephone, wearable electronic device, network-connected (“smart”) device (e.g., a television or home assistant device), augmented reality/virtual reality (AR/VR) system (e.g., head-mounted display), or any electronic device capable of executing a set of instructions that specify action(s) to be taken by the computer system 900. In some implementations, the computer system 900 can be an embedded computer system, a system-on-chip (SOC), a single-board computer (SBC) system, or a distributed system such as a mesh of computer systems or include one or more cloud components in one or more networks. Where appropriate, one or more computer systems 900 can perform operations in real time, near real time, or in batch mode.

The network interface device 912 enables the computer system 900 to mediate data in a network 914 with an entity that is external to the computer system 900 through any communication protocol supported by the computer system 900 and the external entity. Examples of the network interface device 912 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 906, non-volatile memory 910, machine-readable medium 926) can be local, remote, or distributed. Although shown as a single medium, the machine-readable medium 926 can include multiple media (e.g., a centralized/distributed database and/or associated caches and servers) that store one or more sets of instructions 928. The machine-readable medium 926 can include any medium that is capable of storing, encoding, or carrying a set of instructions for execution by the computer system 900. The machine-readable medium 926 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 910, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in computing device(s). When read and executed by the processor 902, the instruction(s) cause the computer system 900 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” or any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A method for integrating a cooling channel into an energy storage device by using additive manufacturing techniques, the method comprising:
depositing, from a first nozzle of a multi-modal printhead, a first electrode material to form a first electrode layer having a first boundary defining a first surface area;
depositing, from a second nozzle of the multi-modal printhead, a thermally functional non-electrode material to form a non-electrode layer having a second boundary that is coextensive with the first boundary, the non-electrode layer including at least one embedded cooling channel extending along a tortuous path across an area of the non-electrode layer, the at least one embedded cooling channel being fluidly connectable to an inlet and an outlet and configured to transport a cooling medium;
depositing, from a third nozzle of the multi-modal printhead, a second electrode material to form a second electrode layer having a third boundary that is coextensive with the first boundary,
wherein the first electrode layer is an anode layer and the second electrode layer is a cathode layer, or vice versa;
performing in-situ consolidation of at least one of the first electrode layer, the non-electrode layer, and the second electrode layer by laser sintering,
wherein the non-electrode material comprises at least one of a thermally conductive material, a thermally insulating material, or a composite thereof, and is configured to dissipate heat generated by the first electrode layer and/or the second electrode layer and improve temperature uniformity across the energy storage device,
wherein the depositing steps comprise at least one of extrusion, slurry-based deposition, or inkjet deposition, and
wherein the at least one embedded cooling channel has a path length greater than a straight-line distance between its fluidic inlet and outlet and a cross-sectional dimension selected to enable heat removal during device operation.

2. The method of claim 1, wherein the non-electrode material comprises a metal, ceramic, diamond, oxide, polymer, or nanocomposite configured to enhance thermal conductivity and mechanical stability of the energy storage device.

3. The method of claim 1, wherein the at least one embedded cooling channel comprises a serpentine, helical, fractal, lattice, or branched geometry.

4. The method of claim 1, further comprising:
forming a header or manifold in fluid communication with the at least one embedded cooling channel to interface with a cooling loop at cell, module, or pack level.

5. The method of claim 1, wherein the cooling medium comprises a liquid, gas, phase-change material, or thermally conductive gel.

6. The method of claim 1, further comprising:
post-processing by at least one of thermal annealing, UV curing, chemical curing, pressure-assisted densification, or laser remelting to improve adhesion, conductivity, or structural integrity.

7. The method of claim 1, wherein the printhead further comprises an alignment system configured to maintain registration between the first electrode layer, the non-electrode layer, and the second electrode layer within a predetermined tolerance.

8. The method of claim 1, wherein the energy storage device comprises a lithium-ion battery, a solid-state battery, a sodium-ion battery, or a supercapacitor.

9. The method of claim 1, wherein the first electrode material or the second electrode material comprises a nanostructured active material configured to enhance thermal and mechanical stability.

10. The method of claim 1, wherein the laser sintering occurs contemporaneously with deposition of at least one layer to provide in-situ consolidation.

11. The method of claim 1, wherein the at least one embedded cooling channel is positioned between the first electrode layer and the second electrode layer and extends across the coextensive boundary.

12. The method of claim 1, wherein the non-electrode layer includes regions of thermally insulating material positioned to reduce parasitic heat transfer to adjacent cells or components.

13. The method of claim 1, wherein the method further comprises:
printing electrical interconnects and current collectors aligned with the first and second electrode layers.

14. The method of claim 1, wherein the at least one embedded cooling channel includes thermally conductive lining material configured to increase heat conductance to the cooling medium.

15. An additive manufacturing method comprising:
depositing an anode material to form an anode layer;
depositing a thermally functional material to form a cooling layer including at least one embedded cooling channel being fluidly connectable to an inlet and an outlet and configured to transport a cooling medium;
depositing a cathode material to form a cathode electrode,
wherein the anode layer is deposited before or after the cathode layer is deposited; and
laser sintering at least one of the anode layer, the cathode layer, and the cooling layer,
wherein the thermally functional material comprises at least one of a thermally conductive material, a thermally insulating material, or a composite thereof, and is configured to dissipate heat generated by the anode layer and/or the cathode layer.

16. The method of claim 15, wherein the at least one embedded cooling channel has a path length greater than a straight-line distance between its fluidic inlet and outlet.

17. The method of claim 15, wherein the non-electrode material comprises a metal, ceramic, diamond, oxide, polymer, or nanocomposite configured to enhance thermal conductivity and mechanical stability of the energy storage device.

18. The method of claim 15, wherein the at least one embedded cooling channel comprises a serpentine, helical, fractal, lattice, or branched geometry.

19. An energy storage device comprising:
a first electrode layer formed of a first electrode material and having a first boundary defining a first surface area;
a non-electrode layer positioned adjacent to the first electrode layer and having a second boundary that is coextensive with the first boundary, the non-electrode layer comprising a thermally functional material and at least one embedded cooling channel extending along a tortuous path across an area of the non-electrode layer, the at least one embedded cooling channel being fluidly connectable to an inlet and an outlet and configured to transport a cooling medium;
a second electrode layer formed of a second electrode material and having a third boundary that is coextensive with the first boundary, the second electrode layer positioned on an opposite side of the non-electrode layer from the first electrode layer, wherein the first electrode layer is an anode layer and the second electrode layer is a cathode layer, or vice versa;
one or more consolidated regions in at least one of the first electrode layer, the non-electrode layer, and the second electrode layer providing structural integrity and interlayer adhesion,
wherein the thermally functional material of the non-electrode layer comprises at least one of a thermally conductive material, a thermally insulating material, or a composite thereof and is configured to dissipate heat generated by the first electrode layer and/or the second electrode layer, and
wherein the at least one embedded cooling channel has a path length greater than a straight-line distance between its fluidic inlet and outlet.

20. The energy storage device of claim 19, wherein the at least one embedded cooling channel comprises a serpentine, helical, fractal, lattice, or branched geometry and extends substantially across the coextensive boundary of the non-electrode layer.
